(19) United States
(12) Patent Application Publication
(10) Pub. No.: US 2026/0278338 A1
(43) Pub. Date: Sep. 17, 2026

(54) Recursive Architecture for Graph-Based Auto-Encoder

(71) Applicant: Mitsubishi Electric Research Laboratories, Inc., Cambridge, MA (US)

(72) Inventor: Anoop Cherian, Cambridge, MA (US)

(73) Assignee: Mitsubishi Electric Research Laboratories, Inc., Cambridge, MA (US)

(21) Appl. No.: 19/079,022

(22) Filed: Mar. 13, 2025

(51) Int. Cl. G06N 3/0455; G06N 3/042

(52) U.S. Cl. CPC G06N 3/0455; G06N 3/042

(57) ABSTRACT

Embodiments disclosing a recursive architecture for a graph auto-encoder are provided. The recursive architecture includes a graph-based encoder configured to recursively encode input graph data into a latent representation. The recursive architecture further includes a transformer-based decoder configured to recursively decode the latent representation into output graph data using different numbers of learned query embeddings for at least some of iterations of the recursive decoding.

### TECHNICAL FIELD

The present disclosure relates generally to graph networks, and more specifically to generation of recursive graph networks for multimodal large language models.

### BACKGROUND

Inference capabilities of artificial intelligence (AI) models have increased in recent years, due to the advancements of transformer architectures and their use in training large language models on internet-scale datasets. Despite this progress, the performance of such architectures on non-textual data, such as images, speech, and videos, are still below expectations when compared to what humans can do. This is mainly due to the large redundancy and sparsity in the semantically useful content captured within such modalities of the non-textual data and the inability of the AI models to gather, assimilate, and deduce compact representations that capture the essence of such content.

Extraction and characterization of semantic details within various perceptual modalities in order to prepare them to be useful in a multimodal artificial general intelligence setup is a problem that is still actively explored.

Thus, there exists a need for systems and methods that may address the problems and challenges discussed above.

### SUMMARY

Some embodiments disclose use of graph neural networks for representing evolving spatio-temporal content associated with multimodal input data.

To that end, some embodiments disclose a model that receives multimodal data as input, the multimodal data including an image, a streaming video, text data, citation networks, spatio-temporal graphs, or a combination thereof. As there is significant redundancy in the content of images or videos at the pixel level for such multimodal input data, a pre-trained object detector and a relationship detector may be applied to the multimodal input data to compactly capture the input as a scene graph, where the nodes of the scene graph represent the objects, and the edges capture the relationships. The relationships could be either spatio-temporal proximity (e.g., book near lamp) or commonly used verbs (such as a person holding glass), and the like.

Some embodiments are based on an understanding that such a model may be used for a downstream task such as summarizing a scene or asking a question about a specific object such as what is the color of the ball, or to identify a relation in the scene, such as what is next to the laptop. Some tasks may be associated with asking questions that need human experience, e.g., what is the relation between the two people in the image, and the like. Such details are not available if the multimodal input data received from a scene of the task is stored only with specific details from the image as provided by the object or relationship detector. To this end, some embodiments are based on a recognition that to process the multimodal input data to better fulfil the requirements of these tasks, it is required that the multimodal input data be stored in a better representation, that can capture more information from the scene about the task than is previously done. Therefore, some embodiments disclose storing the multimodal input data as neural feature vectors associated with each object in the scene. To that end, storing the multimodal input data in this manner captures the scene sparsity at a semantic granularity that is above that of pixel details, thereby reducing information redundancy and providing more information for improved task performance.

Some embodiments are further based on a recognition that while using scene graphs allows sparse representation of the visual information, the amount of data that needs to be stored is still large as the data semantic features may need to be produced, stored, and provided to an inference engine which may use this data for task performance. This is especially problematic when considering video data where there could be streaming features coming from every video frame.

Some embodiments are further based on a recognition that it may be challenging to understand how to prepare this data to be fed to a large language model (LLM) for inference. Typically, such LLMs are pre-trained for efficiency and a common approach is to adapt the perceptual data so that it is mapped to the space of language embeddings that the LLMs can then reason on to apply their pre-trained language understanding for inference (e.g., for answering a question such as: what is the relation between the two people in the image). To that end, some embodiments are based on a recognition that having very large scene graph representations could entail large compute infrastructures for training the LLMs or for expanding the input fovea of such models (i.e., the number of input tokens they can use), which could need their re-design.

Some embodiments disclose a solution to the above problem using the idea of recursive architecture for a graph auto-encoder. To that end, some embodiments disclose a recursive architecture for a graph auto-encoder (GAE) model that may compress an entire input graph into an embedding feature vector. This is unlike known GAEs that predict edges from node embeddings or semantic segmentation.

To that end, some embodiments disclose the recursive architecture for the GAE including a graph based encoder to recursively compress the input graph to a latent representation and a transformer-based decoder for reconstructing the graph from the latent representation. This decoder is designed to decode the graph from its encoding into the latent representation. In this recursive architecture, the encoder recursively encodes the graph into a latent representation and/or the decoder recursively decodes this latent representation back into the representation of the original graph or a portion of it. This approach enables the encoding of the entire graph into a single feature vector within a suitable latent space, facilitating efficient storage and transmission of data associated with a scene from which the graph is built, as well as decoding from that latent space as needed to perform a downstream task.

Some embodiments are based on a recognition that prior works known in the art have not applied a transformer-based architecture to the task of compressing multimodal input data and deriving useful information from such data for inference based tasks, despite its advancements in LLMs on internet-scale datasets. Some embodiments are further based on a recognition that the performance of such architectures on non-textual data-such as images, speech, and videos-remains below expectations. This is primarily due to the significant redundancy and sparsity in the semantically useful content within these modalities, and the current limitations of AI models in capturing, assimilating, and deducing compact representations that encapsulate the essence of such content.

However, some embodiments recognize the advantages of using a transformer-based decoder within the framework of graph auto-encoders. Specifically, if a recursive decoder sequentially decodes the latent representation of the graph, the encoder is also configured to encode the graph in a sequential or linear recursion. This constraint on the encoder's implementation can lead to inefficiencies. For instance, in certain practical scenarios, it is preferable for the recursion to form a tree structure rather than being linear. This allows useful nodes for inference to be decoded in logarithmic time, enhancing efficiency compared to linear decoding.

Some embodiments are based on a recognition of potential flexibility of the transformer-based decoder in handling various types of recursive encoding. This flexibility is facilitated by learned query embeddings, which act as non-linear filters to disentangle encoded elements within a given embedding feature. This allows for the use of an arbitrary number of such queries to generate features for a subsequent decoding layer, similar to using orthonormal subspaces for linear feature embeddings. Consequently, the encoding strategy can be arbitrary, provided that the metadata of the encoding guides the selection of the number of learned queries for recursive decoding. The ability of the transformer-based decoder to work with different numbers of queries during various iterations of the recursive decoder enables the disentangling of different iterations of the recursive encoding, thereby adding the desired flexibility.

Accordingly, some embodiments disclose a recursive architecture for a graph auto-encoder (GAE). The recursive architecture comprising a graph-based encoder configured to recursively encode input graph data into a latent representation. The recursive architecture further comprising a transformer-based decoder configured to recursively decode the latent representation into output graph data using different numbers of learned query embeddings for at least some of iterations of the recursive decoding.

According to some embodiments, a method is provided. The method includes receiving input graph data associated with a scene. The method also includes encoding recursively the input graph data into a latent representation. The latent representation includes an embedding feature vector corresponding to the input graph data. The method further includes decoding recursively the latent representation into output graph data using different numbers of learned query embeddings for at least some iterations of the recursive decoding

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1 illustrates a block diagram of a system including a recursive graph auto-encoder (RGAE) having a recursive architecture, according to an embodiment of the present disclosure.

FIG. 2 illustrates a block diagram showing details of the graph generator, according to an embodiment of the present disclosure.

FIG. 3A illustrates a schematic diagram showing an example graph generator, according to an embodiment of the present disclosure.

FIG. 3B illustrates a block diagram of generation of an input graph by the example graph generator of FIG. 3A, according to some embodiments of the present disclosure.

FIG. 4A illustrates a block diagram of a recursive graph auto-encoder (RGAE), according to an embodiment of the present disclosure.

FIG. 4B illustrates a flowchart of a method executed by the RGAE, according to an embodiment of the present disclosure.

FIG. 5A illustrates a block diagram showing a detailed architecture of the RGAE of FIG. 4A, according to an embodiment of the present disclosure.

FIG. 5B illustrates a schematic diagram showing different graph tokens corresponding to the minimum VC, according to an embodiment of the present disclosure.

FIG. 5C illustrates a schematic showing generation of nodes at an output of the subgraph pooling module, according to an embodiment of the present disclosure.

FIG. 5D illustrates a block diagram of an example of a layer of operation of the subgraph pooling module for a recursion operation, according to an embodiment of the present disclosure.

FIG. 6 illustrates a block diagram showing details of the subgraph unpooling module, according to an embodiment of the present disclosure.

FIG. 7 illustrates a schematic diagram showing details of the graph unpooling module, according to an embodiment of the present disclosure.

FIG. 8A illustrates a schematic diagram showing an example use case for implementation of the system including the RGAE, according to an embodiment of the present disclosure.

FIG. 8B illustrates a schematic diagram showing another example use case for implementation of the system including the RGAE, according to an embodiment of the present disclosure.

FIG. 9 illustrates some components of a control system for controlling a robot according to a task, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art that fall within the scope and spirit of the principles of the presently disclosed embodiments.

### DETAILED DESCRIPTION

The following description provides exemplary embodiments only and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as outlined in the appended claims.

Specific details are given in the following description to provide a thorough understanding of the embodiments. However, understood by one of the ordinary skills in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail to avoid obscuring the embodiments. Further, reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware, or microcode, the program code or code segments to perform the necessary tasks may be stored in a machine-readable medium. A processor(s) may perform the necessary tasks.

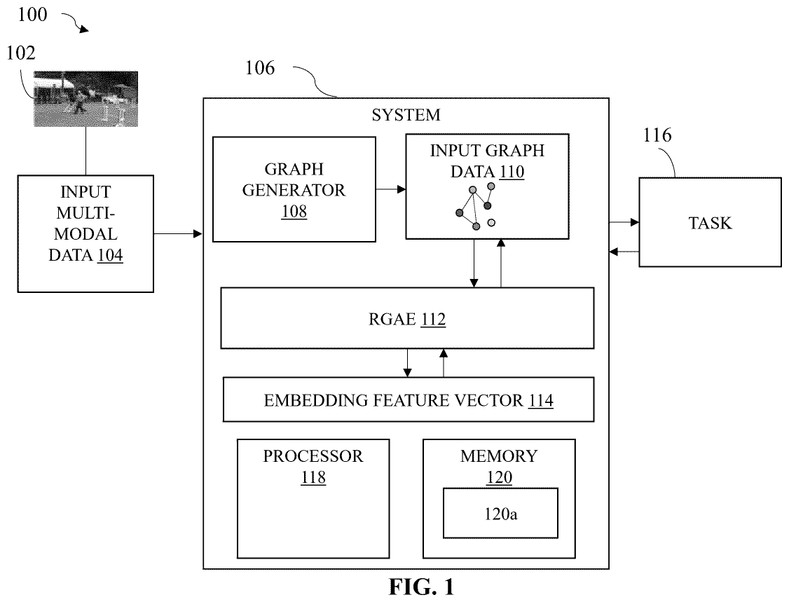

FIG. 1 illustrates a block diagram 100 of a system 106 including a recursive graph auto-encoder (RGAE) 112 having a recursive architecture, according to an embodiment of the present disclosure.

The system 106 may be configured to operate in an environment associated with a scene 102. The scene 102 may be an audio-visual scene, a video scene, an audio scene, an image, a text citation and the like. The scene 102 may generate input multi-modal data 104 having different modalities including but not limited to an audio modality, a video modality, a text modality, an image modality, and the like. In an example, the scene 102 includes a human user operating in an environment, such as a room, or a ground in which different objects are placed. The scene 102 may be captured by a camera which may generate streaming video data as the input multimodal data 104.

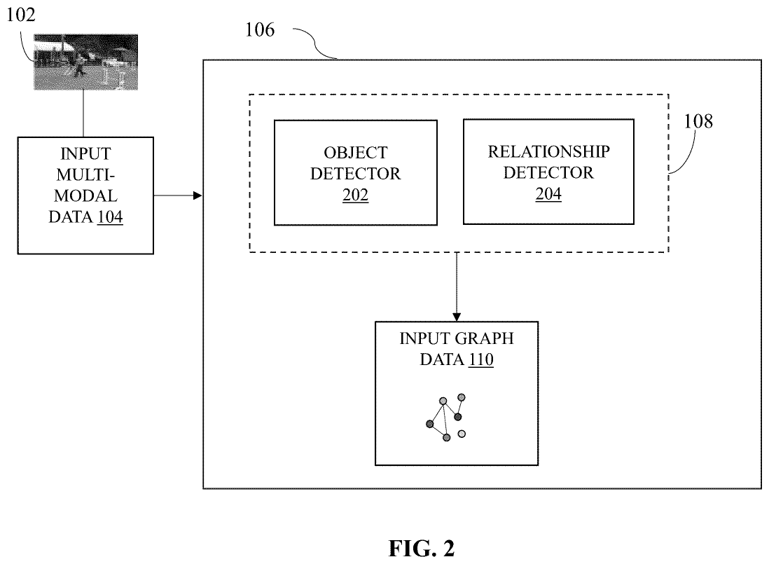

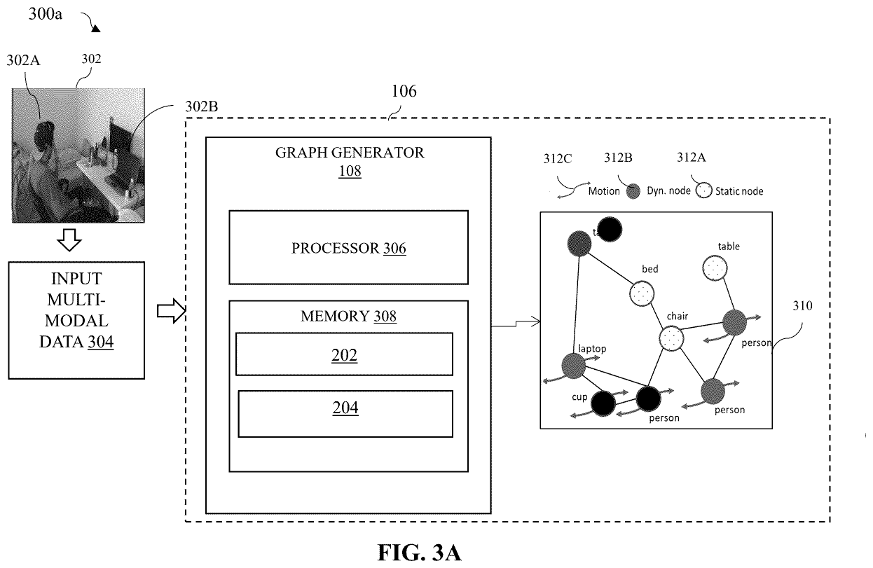

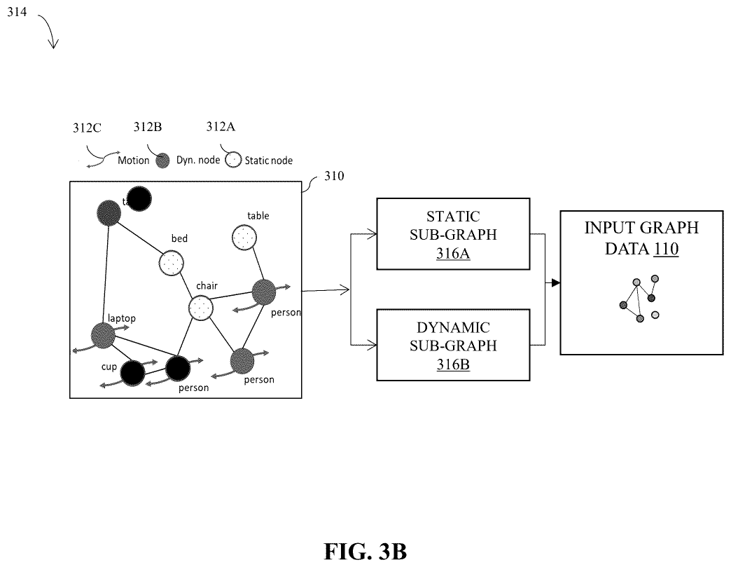

The input multimodal data 104 is passed to the system 106 which includes a graph generator 108 that may convert the input multimodal data 104 from the scene 102 into input graph data 110. The graph generator 108 is further explained in conjunction with FIG. 2, FIG. 3A, and FIG. 3B.

The system 106 also includes the RGAE 112 which receives the input graph data 110. The RGAE 112 includes the recursive architecture having a graph-based encoder configured to recursively encode the input graph data 110 into a latent representation. The latent representation is generated in the form of an embedding feature vector 114 which includes a compact representation of the input graph data 110. The RGAE 112 also includes a transformer-based decoder that is configured to recursively decode the latent representation into output graph data using different numbers of learned query embeddings for at least some of iterations of the recursive decoding. The output graph data is used to train the graph-based encoder to ensure the learned embedding feature vector 114 captures the input graph data 110 correctly. Further, the output graph data can be used for conditional recursive decoding in downstream applications. Specifically, in a downstream application, if the nodes or edges of the input graph data 110 that are recursively embedded in the embedding feature vector 114 needs to be used for inference, then the decoded output graph data is used.

In an embodiment, the embedding feature vector 114 is decoded by the RGAE 112 back to the input graph data 110 using the transformer-based decoder of the RGAE 112. To that end, the RGAE 112 allows compression of information using the embedding feature vector 114, but if a downstream task, such as the task 116, needs to work with the original input graph data 110, then the embedding feature vector 114 is decoded to the input graph data 110 for performing the task 116. To that end, since the embedding feature vector 114 is recursively encoded, the decoding is conditionally recursive. That is, from the embedding feature vector 114, the input graph data 110 is decoded, and each node of the decoded graph is an embedding like the embedding feature vector 114. The extent of decoding depends on the underlying task 116. Thus, based on the task 116, only one or some of the nodes of the embedding feature vector 114 may be decoded into their corresponding input graphs. For example, if the task 116 is a question answering task, the question could be about ‘what color is a person's shirt?’ in the scene 102 and the embedding feature vector 114 may embed the entire scene 102. However, while decoding the embedding feature vector 114, in some iteration of decoding, a graph with nodes corresponding to person and other things in the scene 102 may be obtained. In this graph the node for the person may be embedded in the embedding feature vector 114.

In some embodiments, the functionality of the RGAE 112 are implemented by having different modules embodying the components of the RGAE 112, such as the graph-based encoder, the transformer-based decoder, and the like. The term “module” refers to a structural or computational component that may be implemented in hardware, software, firmware, or any combination thereof. A module may be embodied as a circuit, processing unit, memory structure, stored program, computer-executable instructions, or other suitable implementation that facilitates data processing, computation, or control operations. When implemented in software, a module may comprise computer-executable instructions stored in a non-transitory computer-readable medium, which, when executed by a processor, perform specified functions. The module may be arranged as a standalone unit or integrated within a broader system architecture and may interact with other modules, components, or systems through wired or wireless communication interfaces. The specific implementation of a module is not limited to any particular form and may include processors, controllers, application-specific integrated circuits (ASICs), field-programmable gate arrays (FPGAs), stored program control logic, or any combination of machine-executable instructions and hardware configurations.

In some embodiments, the system 106 includes a memory 120 that stores instructions 120a corresponding to the different modules. The instructions 120a stored by the memory 120 are executed by a processor 118, that causes the different modules to be executed to perform their functionality.

The processor 118 may be any device, circuit, or computational unit capable of executing computer-executable instructions, stored programs, or controlling logic to perform operations on data. The processor 118 may be implemented as a general-purpose processing unit, such as a central processing unit (CPU), or as a specialized processor, including but not limited to a graphics processing unit (GPU), digital signal processor (DSP), application-specific integrated circuit (ASIC), field-programmable gate array (FPGA), or neural processing unit (NPU). The processor 118 may be a single-core or multi-core device, and it may operate independently or in coordination with other processors. The processor 118 may be integrated within a single device or distributed across multiple systems, communicating via wired or wireless interfaces. When executing software, a processor retrieves and processes computer-executable instructions stored in a non-transitory computer-readable medium, facilitating various computational, control, and data processing functions. The term “processor” is not limited to any specific architecture and may encompass any hardware or combination of hardware and software capable of executing instructions to perform the described functionalities.

The memory 120 may be any tangible, non-transitory computer-readable storage medium or device capable of storing data, instructions, or executable code. Memory 120 may include, but is not limited to, volatile memory (e.g., random-access memory (RAM)), non-volatile memory (e.g., read-only memory (ROM), flash memory, solid-state drives (SSDs), magnetic storage, optical storage), or any combination thereof. Memory 120 may be local to a device, distributed across multiple devices, or accessible via a networked storage system. In certain embodiments, the memory 120 may store software instructions, machine learning models, configuration parameters, user data, or other information necessary for the operation of a computing system, such as in the form of the stored instructions 120a.

In an example, the system 106 outputs the embedding feature vector 114 which may be further used to perform a task 116. The task 116 may be any of a summarization task, an audio-visual question answering task, an embodied navigation task, and the like.

In an embodiment, the task 116 is a question-answer task where an LLM model receives the embedding feature vector 114 as a compact representation of the entire scene 102 and uses this embedding feature vector 114 to answer queries about the scene 102 in the form of an LLM interface or using natural language.

In some embodiments, the task 116 is summarizing the scene 102 in compact representation to prepare a dataset for use by an LLM model. In this embodiment, the graph generator 108 provides a different scene graphs to the RGAE 112 which compresses the scene graphs recursively into a single embedding feature vector using recursive architecture. This single embedding feature vector is generated as the embedding feature vector 114 output from the system 106, which then uses this output further with various LLM models.

FIG. 2 illustrates a block diagram showing details of the graph generator 108, according to an embodiment of the present disclosure. The graph generator 108 is part of the system 106 that receives the input multi-modal data 104 from the scene 102 and converts this input multimodal data 104 into a scene graph, which is used as the input graph data 110. A scene graph is a data structure that is used to organize and manage objects in a scene. It represents the hierarchical relationships between objects in a virtual world. The scene graph includes nodes and edges. Thus, the input graph data 110 corresponding to the scene graph of the scene 102 includes different nodes, where each object in the scene 102 (like a car, tree, or light source) is represented as a node in the scene graph. Further, the input graph data 110 may include data associated with a hierarchy in which the objects are connected in a parent-child structure. Each node has properties like position, rotation, and scale. The nodes may be connected in the form of a tree-like structure.

The graph generator 108 includes an object detector 202 and a relationship detector 204, that are configured to operate to convert data of different objects in the scene 102 into the input graph data 110. The scene 102 may be part of a video captured using an image capturing device from a site of occurrence of an event or activity of one or more users/humans. The graph generator 108 is configured to construct a structured representation of the scene 102 by analyzing the multimodal input data 104, which can include images, text, and other sensory inputs. The graph generator 108 processes this data to identify objects, their attributes, and the relationships between them, ultimately forming a scene graph that encodes these elements in a structured format. This structured representation facilitates higher-level reasoning and enables various applications such as image captioning, visual question answering, and robotic perception.

The graph generator 108 includes the object detector 202 and the relationship detector 204 that work in conjunction to extract relevant entities and their interactions from the multimodal input data 104. The object detector 202 detects and classifies one or more objects within the scene 102, while the relationship detector 204 determines how these objects relate to one another based on spatial, semantic, or contextual cues. Thus, the relationship detector 204 detects one or more relationships between the detected one or more objects in the scene 102.

In an embodiment, the object detector 202 includes a deep neural network, such as a convolutional neural network (CNN) or a transformer-based model, trained to identify and classify objects within multimodal input data 104. The neural network processes image data to detect object boundaries and labels, leveraging pre-trained features or end-to-end learning to improve detection accuracy. Alternatively, a rule-based or heuristic object detection approach may be employed, where predefined templates or feature-matching techniques are used to recognize objects based on known patterns. Hybrid implementations may also combine neural networks with traditional computer vision techniques, such as edge detection or histogram-based segmentation, to enhance detection performance in specific use cases.

In an embodiment, the relationship detector 204 includes a neural network, such as a graph neural network (GNN) or a recurrent neural network (RNN), trained to predict relationships between detected objects based on contextual cues and learned embeddings. This model may process both spatial relationships and semantic connections derived from multimodal data to generate a structured scene representation. In another embodiment, statistical or probabilistic methods, such as Bayesian networks or Markov random fields, can be used to infer relationships between objects based on prior knowledge and observed data patterns. Additionally, knowledge-based systems leveraging predefined ontologies and rule-based inference mechanisms may be employed to determine relationships using a structured knowledge base, ensuring logical consistency in relationship extraction.

Based on the execution of the graph generator 108, one or more objects and their relationships are identified, which are then converted into nodes and edges corresponding to the scene graph. The data of the nodes, edges, objects and relationships to form the scene graph, forms the input graph data 110.

FIG. 3A illustrates a schematic diagram 300a showing an example implementation of the graph generator 108, according to an embodiment of the present disclosure.

The schematic diagram 300a illustrates a scene 302 in a video, that is input multimodal data 304, that may include different objects that may be static or dynamic. For instance, the scene 302 includes an object 302A and an object 302B. The object 302A may correspond to a dynamic object, such as a person moving in the scene 302 and the object 302B may correspond to a static object, such as a laptop that remains static on a table in the scene 302. Such scene 302 of the input multimodal data 304 may be processed by the system 106.

The system 106 includes the graph generator 108 that may cause processing of the scene 302 to perform a task such as providing a transcription of the video of the scene 302 and/or providing a response to a query pertaining to the scene 302. The graph generator 108 includes a processor 306 and a memory 308. The memory 308 is configured to store instructions that are executed by the processor 306. To that end, the memory 308 is configured to store instructions corresponding to implementation of the object detector 202 and the relationship detector 204. The graph generator 108 is configured to receive a sequence of video frames of the input multimodal data 304. The received sequence of video frames are pre-processed to output a pre-processed sequence of video frames in an embodiment. The pre-processed sequence of video frames may be generated by the object detector 202 (shown in FIG. 2) and includes objects detected in the video frames of the input multimodal data 104 as well as depth information of the objects in the video frames. The object detector 202 may be stored in the memory 308 and instructions corresponding to functions performed by the object detector 202 are executed by the processor 306. In some embodiments, the object detector 202 includes an object detection model for object detection in each of the video. In some example embodiments, the object detection model may include a Faster Region Convolutional Neural Network (FRCNN) object detection model. The FRCNN object detection model may be pre-trained to detect objects in the video frames. In some example embodiment, the FRCNN object detection model may be pre-trained based on a training dataset, such as visual genome dataset. The training dataset may be a broad array of daily-life indoor and outdoor objects. In each video frame, the FRCNN object detection model detects ‘m’ objects in the video frames.

The object detector 202 and the relationship detector 204 transform each of the video frames of the input multimodal data 304 into a spatio-temporal scene graph 310 (G) of the video frames to capture spatio-temporal information of the video frames in the multimodal input data 304. The spatio-temporal scene graph 310 (G) for the sequence video frames (S) with a length of ‘n’ video frames may be represented as G=(V, E), where V=V1∪V2∪ . . . ∪Vn denotes a set of nodes, each Vt denotes the set of nodes associated with frame t, and E⊆V×V denotes set of graph edges. The spatio-temporal scene graph 310 is a pseudo 3D-structure, such as a 2.5D structure that includes nodes representing the detected objects ‘m’ of the video frames of the input multimodal data 304. In particular, each of the ‘m’ objects is represented by a graph node ‘v’ that contains a tuple of FRCNN outputs

$$( {f}_{v}^{o} , cv , bboxv )$$

of the FRCNN object detection model, where fv is the object's neural representation, cv is corresponding label of an object in the training database, and bboxv denotes corresponding bounding box coordinates relative to corresponding video frame of the sequence of video frames. Thus, for the sequence of video frames with ‘n’ video frames, the spatio-temporal scene graph 310 includes ‘mn’ graph nodes.

The graph nodes of the spatio-temporal scene graph 310 includes one or multiple static nodes 312A and one or multiple dynamic nodes 312B. The one or multiple static nodes 312A represent corresponding static objects (e.g., the object 302B) in the video frames of the input multimodal data 304. The one or multiple dynamic nodes 312B represent corresponding dynamic objects (e.g., the object 302A) in the video frames of the input multimodal data 304. The one or multiple dynamic nodes 312B includes motion features 312C that represent information of movement of the dynamic nodes 312B. In some example embodiments, the motion features 312C are extracted from the dynamic graph nodes of the spatio-temporal scene graph using an action recognition model, e.g., an Inflated 3D networks (I3D) action recognition model.

In the spatio-temporal scene graph 310 each of the graph nodes (static or dynamic) has properties that represent the corresponding object. For instance, a static graph node has properties that represent an appearance and a location of a corresponding static object. Likewise, a dynamic graph node has properties representing an appearance, a location and a motion of corresponding dynamic object at different instances of time.

For a graph node v∈Vt extracted from a video frame at a time instance t (i.e., an image It), let bboxv denotes a centroid of the node's detected bounding box. In some embodiment, to enrich the spatio-temporal scene graph 310 with (2.5+1)D spatio-temporal information, representation of the graph node (v) is incorporated with depth and time information. The depth and time information is incorporated to the graph node (v) by updating the tuple for the graph node (v) as

$$( {f}_{v}^{o} , cv , bboxv , pv , t ) ,$$

where pv=dIt b̅b̅o̅x̅ᵥ̅ is interpreted as a 3D centroid of the bounding box. The enriched spatio-temporal scene graph 310 is denoted as G3.5D graph.

Further, from the spatio-temporal scene graph 310 (G3.5D graph), graph nodes that correspond to the static objects are pruned to remove redundant or copy of the graph nodes, which is described next in FIG. 3B.

It may be understood by one of ordinary skill in the art that the scene graph generation using the graph generator 108 is depicted for an example scene 302 only for illustration purposes. The same functionality of the graph generator 108 may be equivalently applied to any scene, such as the scene 102 and their corresponding input multimodal data 104 without deviating from the scope of the present disclosure.

FIG. 3B shows a representation 314 for segregation of the spatio-temporal scene graph 310, according to some embodiments of the present disclosure. In some example embodiments, the spatio-temporal scene graph 310 may be segregated based on the class segregation of the objects. The class segregation may correspond to the segregation of a training dataset (e.g., the training dataset of the FRCNN object detection model) into two categories. The two categories may include a category of static objects (Cs) and a category of dynamic objects (Cd). The category of static scene objects (Cs) may correspond to objects, such as a table, sofa, television, etc. The category of dynamic scene objects (Cd) may correspond to objects, such as people, mobile, football, clouds, etc. To that end, the spatio-temporal scene graph 310 is split into a static sub-graph 316A (Gs) and a dynamic sub-graph 316B (Gd) corresponding to whether an object label (Cv) of a graph node v∈V belongs to Cs or Cd. The static sub-graph 316A includes graph nodes belonging to the category of static scene objects (Cs), while the dynamic sub-graph 316B includes graph nodes belonging to the category of dynamic scene objects (Cd).

In some embodiments, the enriched spatio-temporal scene graph 310 graph (G3.5D) is registered in a shared 3D space. In some embodiments, features for the registration are extracted from the graph nodes of the static sub-graph 316A (referred to hereinafter as static graph nodes) features for registration are extracted. The registration features are extracted from the static subgraph nodes to tackle problems due to motion of objects in the video frames of the input multimodal data 302, and/or problems due to motion of a camera capturing the video frames. Specifically, if there is camera motion, then there may be a frame-to-frame 3D projection matrix using point features. The projection matrix may be used to spatially map all the graph nodes (including both the static and the dynamic graph nodes) of the enriched spatio-temporal scene graph 310 into a common coordinate frame.

Some embodiments are based on realization that bounding boxes that define objects in the static nodes may be imprecise. To that end, a criterion (C) to merge two static nodes may be checked. The criterion (C) may include checking whether the static nodes are from frames that are sufficiently close in time, with the same object labels, and with the intersection over union (IoU) of their bounding boxes above a threshold γ. In particular, two nodes (vt, vt′∈Gs) of the enriched graph, from frames with timestamps (t≠t′) such that (|t−t′|<δ), are candidates for merging if the following criterion (C) is met:

$$C ( {v}_{t} , {v}_{{t}^{′}} ) := ( {c}_{{v}_{t}} = {c}_{{v}_{{t}^{′}}} ) ∧ Io U ( {bbox}_{{v}_{t}} , bbo {x}_{{v}_{{t}^{′}}} ) > γ \qquad ( 1 )$$

If a static graph node vt of the static sub-graph 316A has multiple candidate nodes in previous δ frames of the video frames that satisfy the criterion (1), the candidate node with the nearest 3D centroid is selected as the matching node is merged:

$$arg min \qquad ( 2 )$$

$$match ( {v}_{t} ) = {v}_{{t}^{′}} ∈ {V}_{t - δ}^{s} ⋃ … ⋃ {V}_{t - 1}^{s} ‖ {p}_{{v}_{t}} - {p}_{{v}_{{t}^{′}}} ‖$$

$$such that C ( {v}_{t} , {v}_{{t}^{′}} ) = 1$$

where

$${V}_{t}^{s} = \{ {v}_{t} ∈ {V}_{t} \vert {v}_{t} ∈ {G}_{s} \}$$

denotes a set of all static nodes from frame t. The equation (2) selects a best match from previous δ frames that overcomes noise in estimation of the depth information and the bounding boxes associated with the graph nodes. In some example embodiments, the equation (2) may be recursively applied to the enriched graph to determine larger equivalence classes of matched nodes to be merged. An equivalence class may be defined as a set of all nodes that share a single common node, referred to as a common ancestor. The common ancestor may be accomplished by looping over frames t in temporal order, where for each node vt for which a match (vt) exists, the common ancestor node is assigned as, an ancestor (vt)=ancestor (match (vt)), using the following algorithm 1.

Algorithm 1: Identifying common ancestor nodes for merging
$for {v}_{1} ∈ {V}_{t}^{s} do$
ancestor (v₁) := v₁
for t = 2 to n do
$for {v}_{1} ∈ {V}_{t}^{s} do$
if match (v₁) exists then
ancestor (vₜ) := ancestor (match(vₜ))

Finally, for each ancestor, all graph nodes that share the same ancestor are merged into a single graph node. The feature

$${f}_{v}^{o}$$

associated with a new graph node (v) is obtained by averaging the features from all of the graph nodes that merged together. After each equivalence class of matched graph nodes are merged into the single graph node, an updated static sub-graph 316A (Gs′) is obtained. The updated static sub-graph (Gs′) is a reduced version of the static sub-graph 316A (Gs) as redundant static graph nodes are pruned. The pruning of the redundant static graph nodes may improve processing and computation speed of the graph generator 108 and correspondingly the system 106.

Further, graph nodes of the dynamic sub-graph 316B (referred to hereinafter as dynamic graph nodes) are incorporated with motion features (e.g., the motion features 312C). In some example embodiments, the motion features may be incorporated using a neural network, such as I3D action recognition neural network. The I3D action recognition neural network may be pre-trained on dataset, such as Kinetics-400 dataset to generate convolutional features from video frames. The convolutional features may be pooled using a pooling technique (e.g., Region-of-Interest (ROI)). In particular, the convolutional features are ROI-pooled using the original bounding boxes associated with the dynamic graph nodes of the dynamic sub-graph 316B. For instance, the convolutional features may be represented as,

$${f}_{{v}_{t}}^{a} = ROIPool ( I 3 D ( {s}_{t} ) , bbo {x}_{{v}_{t}} ) \qquad ( 3 )$$

where sₜ denotes the video frames of the input multimodal data 304 around the tₜₕ video frame of the video (S), then a feature vector outputted by the FRCNN object detection model are augmented by concatenating the object and motion features as

$${f}_{v}^{o a} ← {f}_{v}^{o} ‖ {f}_{v}^{o} ,$$

for all v∈V_{d}, where ∥ is an operator for feature concatenation.

Further, in some embodiments, the different nodes of the spatio-temporal scene graph 310 corresponding to different spatio-temporal volumes of the scene 302 are encoded into a latent space. The encoding of each node of the different nodes in each of the combinations is weighted with an attention score determined as a function of similarities of spatio-temporal locations of the different nodes in the combination.

The static subgraph 316A and the dynamic subgraph 316B may then be combined to generate the input graph data 110 which captured information of the scene graph 310 corresponding to the scene 302. The input graph data 110 is then further processed using the RGAE 112 to cause the system 106 to perform a downstream task. The downstream task could be general (e.g., the task could be to summarize the scene 302 or ask a question about a specific object such as what is the color of the ball? or relation in the scene such as what is next to the laptop? or could also ask questions that need human experience, e.g., what is the relation between the two people in the image?). To that end, the RGAE 112 causes the system 106 to store neural feature vectors associated with each object in the scene 302. Thus, the input graph data 110 captures the scene sparsity at a semantic granularity that is above that of pixel details, thereby reducing information redundancy. The functionality of the RGAE 112 is explained the conjunction with the following description and accompanying figures.

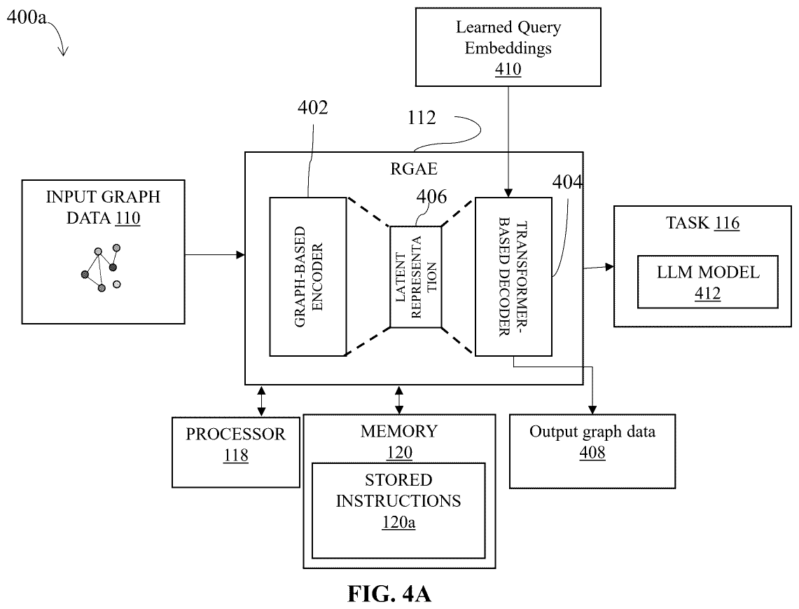

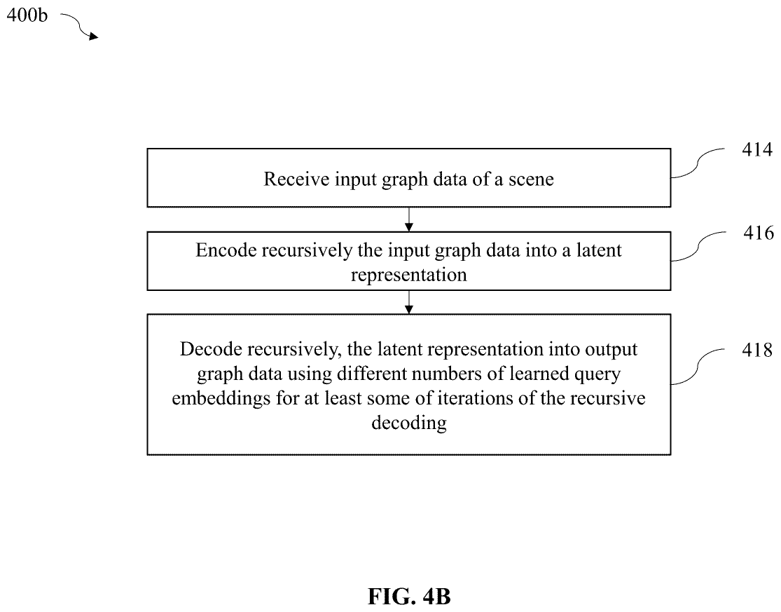

FIG. 4A illustrates a schematic diagram showing example of a recursive architecture 400a for a graph autoencoder, such as the RGAE 112, according to an embodiment of the present disclosure. FIG. 4A is explained in conjunction with elements from FIG. 1, FIG. 2, FIG. 3A, and FIG. 3B described above.

The RGAE 112 is a graph auto-encoder with a recursive architecture. The graph auto-encoder is a type of neural network that is designed to learn low-dimensional representations of graph-structured data in an unsupervised manner. In a most generic sense, the graph auto-encoder consists of an encoder that maps nodes or entire graphs into a latent space and a decoder that reconstructs the graph structure (such as node connections or attributes) from this compressed representation. The RGAE 112 is implemented using the principles of the generic graph auto-encoder and has the recursive architecture 400a shown in FIG. 4A. The recursive architecture 400a includes the processor 118 and the memory 120 having the instructions 120a stored thereon. The instructions 120a when executed by the processor 118, cause the processor 118 to execute modules comprising a graph-based encoder 402 configured to recursively encode the input graph data 110 into a latent representation 406. The modules further includes a transformer-based decoder 404 configured to recursively decode the latent representation 406 into output graph data 408 using different numbers of learned query embeddings 410 for at least some of iterations of the recursive decoding.

The latent representation 406 is stored in the form of a compact representation of the entire input graph data 110. For example, the latent representation may be stored as the embedding feature vector 114 shown earlier in conjunction with FIG. 1. The latent representation 406 may be used for performing a task, such as the task 116.

In one embodiment, the latent representation 406 may be used by an LLM model 412 for performing the task 116, which may be an inference based task. To that end, the latent representation 406 in the form of the embedding feature vector 114 is shared as an input to the LLM model 412 for use while generating an inference. The inference is associated with the input graph data 110 of the scene 102.

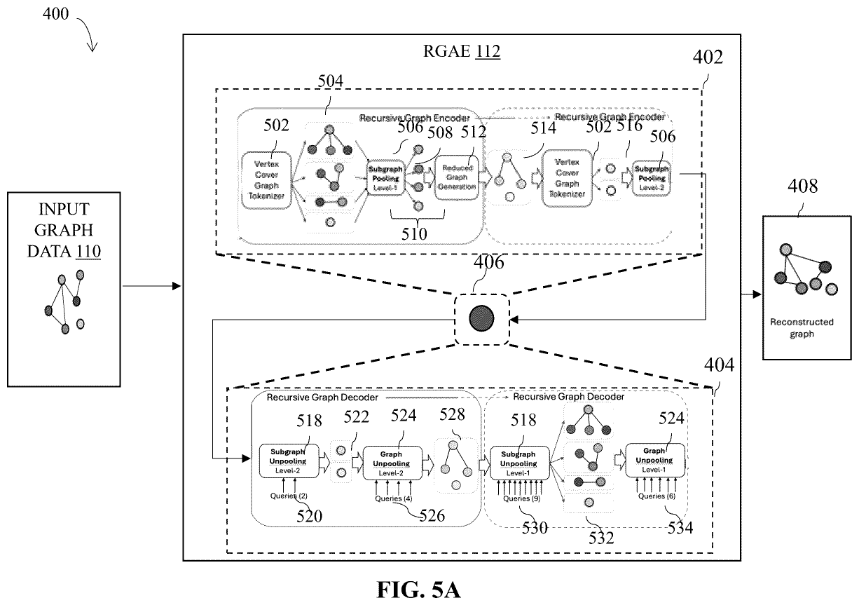

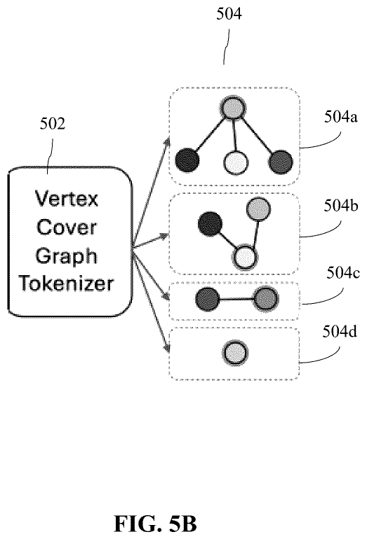

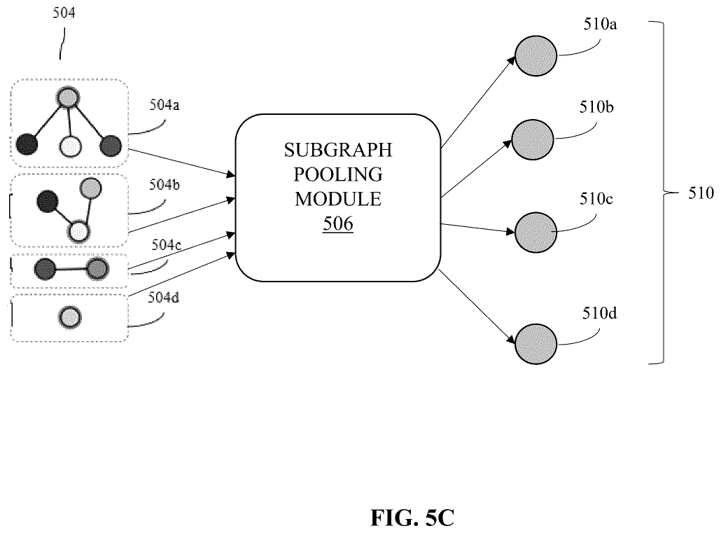

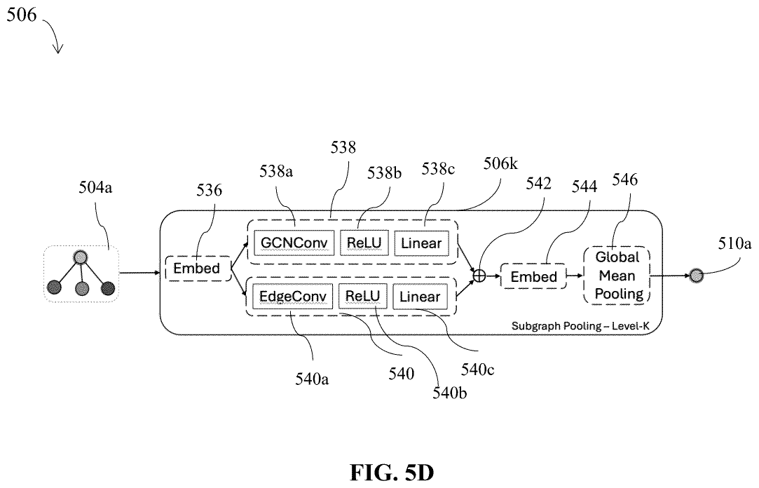

The details of the implementation of the graph-based encoder 402 and the transformer-based decoder 404 are shown in FIG. 5A.

The RGAE 112 with the recursive architecture 400a implements a method 400b shown in FIG. 4B.

FIG. 4B illustrates a flowchart of the method 400b executed by the RGAE 112, according to an embodiment of the present disclosure. The method 400b is executed by the processor 118 in an embodiment. The processor 118 executes stored instructions 120a, that may be stored in the memory 120, to carry out various steps of the method 400b. The steps of the method 400b may include, at 414 receiving input graph data 110 associated with the scene 102. The input graph data 110 has been discussed previously in FIG. 3A and FIG. 3B.

The method 400b further includes, at 416, encoding recursively the input graph data 110 into a latent representation, for example the latent representation 406. The latent representation 406 includes the embedding feature vector 114 corresponding to the input graph data 110. For example, the graph-based encoder 402 is configured to recursively encode the input graph data 110 into the latent representation 406.

In some embodiments, to encoder recursively, the input graph data 110 into the latent representation 406, the method 400b also includes determining a minimum vertex cover for the input graph data 110. A vertex cover is a set of vertices in a graph such that every edge in the graph has at least one endpoint in this set. The smallest possible vertex cover is called the minimum vertex cover. The processor 118 may be configured to determine the minimum vertex cover for the input graph data 110 and further to generate nodes corresponding to one or more subgraphs in the minimum vertex cover based on execution of a subgraph pooling operation. The generated nodes are then used to further generated a reduced subgraph based on the generated nodes, wherein one or more edges are added between one or more nodes of the generated nodes based on a hop distance associated with the one or more nodes. In some embodiments, the generation of the minimum vertex cover, and reduced subgraphs is done recursively based on a termination condition. The termination condition may be specified based on the underlying task 116 or may be predetermined.

In some embodiments, the task 116 is an LLM based task. For example, the task 116 may be a video based question answering task, a video summarization task, a control task for controlling a robot, and the like. To that end, the latent representation 406 in form of the embedding feature vector 114 is transmitted to a large language model (LLM), such as the LLM model 412. The LLM model 412 may be pre-trained for performing the task 116 based on the embedding feature vector. Further, a user input corresponding to the task 116 may be provided. For example, the user input may define the extent of encoding, the termination condition, a query regarding the scene 102, and the like. The LLM model 412 receives the embedding feature vector 114 and generates response data for the user's input.

The details of the encoding performed by the graph-based encoder 402 are explained in conjunction with FIG. 5A, FIG. 5B, FIG. 5C, and FIG. 5D.

The method 400b also includes, at 418, decoding recursively the latent representation 406 into output graph data using different numbers of learned query embeddings for at least some of iterations of the recursive decoding. For example, the transformer-based decoder 404 is configured to recursively decode the latent representation 406 into output graph data 408 using different numbers of learned query embeddings 410 for at least some of iterations of the recursive decoding.

In some embodiments, the method 400b includes receiving the latent representation 406 and the set of learnable query embeddings 410, where the set of learnable query embeddings 410 comprises the learned query embeddings. Further, the method 400b includes extracting subgraphs from the latent representation 406 based on the application of the learned query embeddings 410 to a subgraph unpooling operation, wherein the subgraph unpooling operation is associated with a transformer model. The method 400b may further include generating a compact graph based on the extracted subgraphs and the set of learnable query embeddings 410.

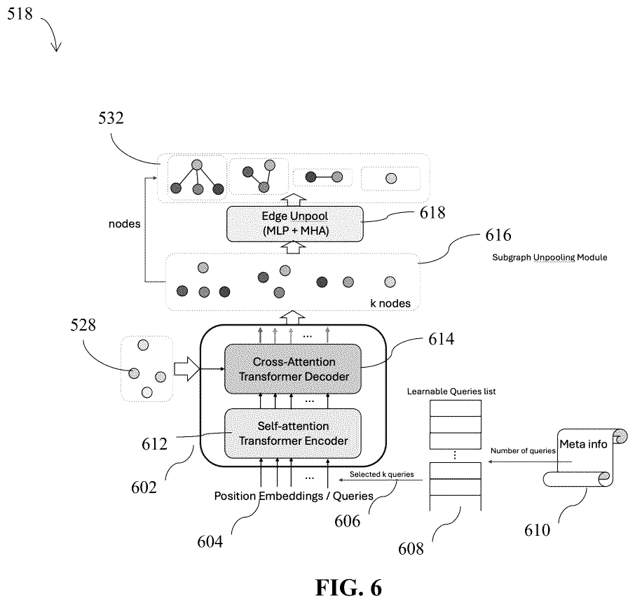

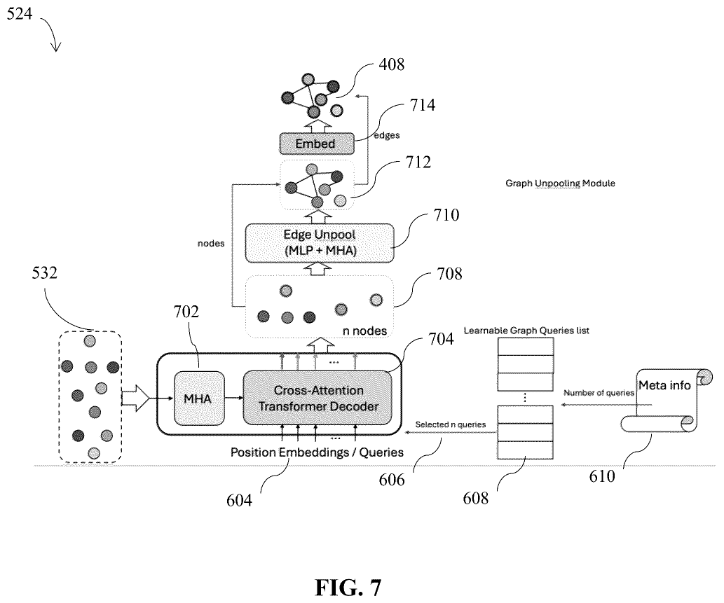

The details of the decoding performed by the transformer-based decoder 404 are explained in conjunction with FIG. 5A, FIG. 6, and FIG. 7.

FIG. 5A illustrates a schematic showing details of the recursive architecture 400a for the graph auto-encoder, that is the RGAE 112, according to an embodiment of the present disclosure.

The details of the recursive architecture 400a illustrate the graph-based encoder 402 at the top and the transformer-based decoder 404 at the bottom.

The graph-based encoder 402 takes as input a scene graph, that is the input graph data 110, which is then split into graph tokens by a vertex cover graph tokenizer 502. The vertex cover graph tokenizer executes computer-instructions to implement a minimum vertex cover algorithm. The minimum vertex cover (VC) cover algorithm includes logic instructions to determine a minimum VC 504 for the input graph data 110. The minimum VC 504 is a subset of nodes in the input graph data 110 such that every edge has at least one end connected to a node in the minimum VC 504. Thus, the minimum VC 504 nodes may be used to summarize all important details in the input graph data 110. Further, each subgraph attached to a node in the minimum VC 504 forms a graph token. This is shown in FIG. 5B.

FIG. 5B illustrates a schematic diagram showing different graph tokens corresponding to the minimum VC 504, according to an embodiment of the present disclosure. A first subgraph 504a forms a first graph token, a second subgraph 504b forms a second graph token, a third subgraph 504c forms a third graph token, and a fourth subgraph 504d forms a fourth graph token. Hereinafter, the terms first subgraph 504a, second subgraph 504b, third subgraph 504c, and fourth subgraph 504d would be interchangeable used to mean first graph token 504a, second graph token 504b, third graph token 504c, and fourth graph token 504d respectively.

In some embodiments, there are also isolated VC nodes as well as two nodes that are both in the VC.

Referring back to FIG. 5A, each subgraph corresponding to the minimum VC 504 is transmitted to a subgraph pooling module 506 that produces a single feature for each of its input subgraph. This feature is identified with the corresponding VC node. That is, the embedding feature associated with the VC node may be replaced with the feature produced by the subgraph pooling module 506.

At the output of the subgraph pooling module 506, only nodes 510 remain in the minimum VC 504. For example, in FIG. 5A, there are multiple nodes, such as a node 508. This is shown in detail in FIG. 5C. FIG. 5C illustrates a schematic showing generation of nodes 510 at an output of the subgraph pooling module 506, according to an embodiment of the present disclosure.

The subgraph pooling module 506 is configured through program instructions executed by a processor to aggregate and compress information from a subgraph into a lower-dimensional representation, often for tasks like graph classification or clustering. It takes a subset of nodes and edges, applies transformations (such as attention mechanisms, mean/max pooling, or learned aggregators), and generates a compact feature vector that captures the essential properties of the subgraph. This is especially useful in hierarchical graph learning, where local structures (subgraphs) need to be represented at different levels of abstraction. For example, the subgraph pooling module 506 takes as input the subgraphs corresponding to the minimum VC 504, that is, the first subgraph 504a, the second subgraph 504b, the third subgraph 504c, and the fourth subgraph 504d. The subgraph pooling module 506 then performs any of the operations disclosed above and generates the nodes 510. The nodes 510 include, for example, a first node 510a which is a compact feature vector representation for the first subgraph 504a, a second node 510b which is a compact feature vector representation for the second subgraph 504b (by way of example, the second node 510b is equivalent to the node 508 shown in FIG. 5A earlier), a third node 510c which is a compact feature vector representation for the third subgraph 504c, and a fourth node 510d which is a compact feature vector representation for the fourth subgraph 504d. Such operation of the subgraph pooling module 506 represents first level of recursive graph encoding performed by the graph-based encoder 402.

FIG. 5D illustrates a block diagram of an example of a layer of operation of the subgraph pooling module 506 for a recursion operation, according to an embodiment of the present disclosure. The subgraph pooling module 506 may include a plurality of subgraph pooling layers that execute recursive pooling at different levels of recursion of the graph-based encoder 402. FIG. 5D illustrates a k-th subgraph pooling layer 506k at a recursion level-k as an example. The k-th subgraph pooling layer 506k takes as an input, the first subgraph 504a. The graph node features of the first subgraph are embedded 536 and then two levels of convolution are performed. A first level of convolution 538 is a node level convolution where a GCNConv 538a operation performs neural message passing to capture the node details. Further, a rectified linear unit (ReLU) 538b adds non-linearity to the features extracted by the GCNConv layer 538a. Without ReLU 538b stacking multiple convolution layers would behave like a single linear transformation, reducing the system's 106 ability to learn complex patterns. The ReLU 538b block helps in handling vanishing gradients by passing only positive values, making training more efficient. It also acts as a sparsity enforcer, setting negative values to zero, improving computation efficiency. Further, a linear 538c block then maps learned feature representations to output classes (e.g., in image classification, the final layer outputs class probabilities).

A second level of convolution 540 is performed at edge level where an EdgeConv 540a operation combines both edge and node features. After the EdgeConv 540a operation, ReLU 540b and a linear 540c layers are used to add non-linearity and add feature representation respectively.

Further the outputs of the first level of convolution 538 and the second level of convolution 540 modules are merged 542 followed by a linear embedding layer 544 and is average pooled by a global mean pooling 546 to produce a single feature in the form of the node 510a for the subgraph 504a.

Referring back to FIG. 5A in conjunction with FIG. 5C and FIG. 5D, a reduced graph generation 512 is done by adding edges to the nodes 510 where an edge is added between a pair of nodes if their hop distance is 2 or less in the original graph, that is the input graph data 110. This process results in a new VC graph 514, which is then treated as a new input graph and the vertex cover graph tokenizer 502 is applied to the new VC graph 514 to determine a new minimum VC 516 corresponding to the new VC graph 514. Further, the subgraph pooling layer 506 is again applied at a second level iteration of the graph-based encoder 402 to the new minimum VC 516 to identify a compact feature vector representation for the new minimum VC 516. The process is recursively applied until only a single node remains, or a set of isolated nodes remain. For example, in the FIG. 5A, the recursive encoding is performed by the graph-based encoder 402 till a single node, that is node 406, remains. It may be understood by one of ordinary skill in the art that in the illustration of FIG. 5A, only two iterations are shown for the graph-based encoder 402 for the sake of brevity of disclosure. Any number of equivalent iterations may be performed by the graph-based encoder 402 to generate the single node or isolated set of nodes disclosed above, without deviating from the scope of the present disclosure.

The node 406 forms the latent representation (hereinafter node 406 and latent representation 406 would be used interchangeably to mean the same) of the input graph data 110, which is a pseudo vertex cover that summarizes the entire input graph 110 corresponding to the scene 102 with a single feature vector. To that end, the node 406 may be equivalent to the embedding feature vector 114 shown earlier in conjunction with FIG. 1. This latent representation 406 is then passed to the transformer-based decoder 404.

The transformer-based decoder 404 is configured to recursively decode the latent representation 406 into output graph data 408 using different numbers of learned query embeddings for at least some of iterations of the recursive decoding. The output graph 408 is isomorphic to the input graph data 110.

The transformer-based decoder 404 includes a subgraph unpooling module 518 that receives the latent representation 406. The subgraph unpooling module 518 also includes a transformer model and a set of learnable query embeddings 520 to extract subgraphs 522 from the embeddings. The transformer-based decoder 404 also includes a second unpooling stage, a graph unpooling module 524. The graph unpooling module 524 that takes the subgraphs 522 as input and merges common nodes to produce a compact graph 528 again using a transformer decoder module with learnable queries 526. The unpooled features are passed through an edge-unpool module to extract the edges between the unpooled nodes. A transformer model is a deep learning architecture designed for processing sequential data while capturing long-range dependencies through self-attention mechanisms. Unlike traditional recurrent or convolutional neural networks, the transformer model employs a self-attention mechanism to weigh the importance of different elements in an input sequence, allowing for parallel processing and improved efficiency.

In some example embodiments, the transformer model may be utilized for processing multimodal input data (such as the input graph data 110 associated with the scene 102), such as text, images, or structured information, to extract contextual relationships and enhance feature representations. The model consists of multiple layers of self-attention and feedforward networks, enabling it to learn complex patterns and relationships within the data. This architecture is particularly beneficial for tasks such as natural language processing, image analysis, and scene graph generation, where contextual understanding and feature fusion from multiple data sources are required.

The two stages of unpooling execute in every iteration of the recursive decoding performed by the transformer-based decoder 404.

Some embodiments are based on a usage of different instantiation of the respective modules for each level of the hierarchy. We also found that given the NP-complete nature of solving the VC problem, using a spanning tree of the initial graph results in faster implementation.

The transformer-based decoder 404 also operates in multiple iterations. For example, FIG. 5A shows two iterations as an example. In a second iteration of the transformer-based decoder, the compact graph 528 is passed through the subgraph unpooling module 518 in the second iteration, and a second subgraph 532 is obtained based on the operation of the subgraph pooling module 518 with a second set of learned query embeddings 530. The second subgraph 532 is then further processed by the graph unpooling module 524 with another set of learned query embeddings 534 to obtain the output graph 408. It may be understood by one of ordinary skill in the art that only two iterations are shown in FIG. 5A only for example purposes, and not to limit the scope of the disclosure. Any equivalent number of iterations may be used to obtain the output graph 408, without limiting the scope of the present disclosure.

FIG. 6 illustrates a block diagram showing details of the subgraph unpooling module 518, according to an embodiment of the present disclosure. FIG. 6 is explained in conjunction with elements from FIG. 5A. The subgraph unpooling module 518 is based on a transformer architecture 602. The subgraph unpooling module 518 takes as input a set of nodes or a single feature, such as the set of nodes of the compact subgraph 528 with the goal of extracting other node features from the input. Further, the transformer architecture 602 of the subgraph unpooling module 518 takes as input a set of queries 604 as a set of learnable position encodings, selected 606 from a list of such embeddings, that is a list of learnable queries 608 indexed numerically. These queries are the same as the queries described in FIG. 5A as the set of learnable query embeddings 520, and the second set of learned query embeddings 530, where 520 refers to a set of queries used in a first level subgraph unpooling module, and 530 for a second level subgraph unpooling module, and the like. These query embeddings are initialized using positional embeddings with learnable parameters and are learned as part of the training of the RGAE 112. A positional embedding is an initialization scheme used in transformers where each query feature is indexed and given a random feature vector signifying its index. These positional embeddings allow a transformer model to distinguish one discrete item from the next even when they have very similar feature embeddings. To that end, the RGAE 112 is configured to for the queries that are initialized as positional embeddings to learn to separate the constituent subgraphs within an embedded feature vector 406. To that end, the set of queries 604 are learnable query embeddings, and the number of such learnable query embedding varies from iteration to iteration. For example, if the unpooled graph needs to have k nodes, then the first k embeddings from the list of learnable queries 608 are selected and are fed as queries the transformer architecture 602 of the subgraph unpooling module 518. The details of how many nodes are needed is taken from meta-data 610 obtained from the graph-based encoder 402. The number of nodes to be decoded, that is the value of k, is stored in the meta-data 610 as part of the graph encoding process. The list of learnable queries are formed when the RGAE 112 is trained end-to-end encoding and decoding the spatio-temporal scene graphs.

Further, the selected set of queries 604 are passed to a self-attention module 612, which are then passed through to a cross-attention transformer-decoder 614, where the set of queries 604 are attended on self-attended node embeddings. The self-attention module 612 self-attention enables each token in an output sequence to attend to previously generated tokens, capturing dependencies regardless of distance. Given an input sequence of token embeddings, self-attention computes attention scores using Query (Q), Key (K), and Value (V) matrices, where each token's query interacts with all previous tokens' keys to determine relevance. The attention scores are normalized using a softmax function, producing weighted values that emphasize important context while suppressing irrelevant parts. To ensure causality, a masking mechanism prevents each token from attending to future tokens, ensuring autoregressive decoding. This process allows the cross-attention transformer decoder 614 to generate context-aware representations for language modeling, machine translation, and other sequence generation tasks.

To that end, during a training time of the subgraph unpooling module 518, the set of queries 604 learn to extract graph node details from the set of input nodes of the compact subgraph 528.

Thus, at execution time, when set of nodes of the compact subgraph 528 are received as compressed node embeddings, the cross-attention transformer decoder 614 cross-attends to the encoder output or compressed subgraph 528 based on the set of queries 604 that are being cross-attended. The cross-attending is done to enable the cross-attention transformer decoder 614 to focus on relevant parts of the encoder's output or the compressed subgraph 528 when generating each token in an output sequence comprising a set of nodes 616.

In an embodiment, the cross-attention transformer decoder 614 receives the Q output from the self-attention module 612. Q represents the decoder's current hidden state, reflecting information about the tokens generated so far. Further, K and V are received as the compact subgraph 528 which corresponds to the encoder's 402 output representations, encapsulating contextual information from the input sequence. The output of the cross-attention transformer decoder 614 is the set of nodes 616 that are similar in semantics to the subgraph nodes 528 used in the encoder. In order to produce edges for the subgraphs in the set of nodes 616, the node features are passed through an edge-unpooling module 618 which comprises a multilayer perceptron (MLP) and multiheaded attention (MHA). The edge unpooling module 618 module takes a pair of nodes and predicts if there is an edge between them. Those pairs are selected to have an edge that have a score more than a threshold. As a result, at the output of the edge unpooling module 618, a set of subgraphs 532 having edges formed between the set of nodes 616 is obtained. The set of subgraph 532 corresponds to the second subgraph 532 shown in FIG. 5A, which is then passed to the graph unpooling module 524, which is explained in detail in FIG. 7.

FIG. 7 illustrates a schematic diagram showing details of the graph unpooling module 524, according to an embodiment of the present disclosure.

The set of subgraphs 532 produced by the subgraph unpooling module 518 contain nodes that are supersets of the actual set of nodes. This is because these set of subgraphs 532 are based on vertex covers, such as the minimum VC 504, and thus a node may be replicated in multiple tokens. These subgraphs need to be uncompacted to produce the original graph input graph data 110. This is done in the graph unpooling module 524. This is similar to the subgraph unpooling module 518, except that the graph unpooling module 524 is the set of nodes 532 produced by the subgraph unpooling module 518.

Firstly MHA 702 is applied on the embeddings corresponding to the set of nodes 532, followed by cross attention 704 using a set of (different) learnable queries 706, with the intention of merging nodes that are similar to form a compact set of nodes as output nodes 708. These output nodes 708 are then passed through an edge-unpooling layer 710 to form the structure of a reconstructed graph 712 isomorphically resembling the input graph data 110. In order to reconstruct the original features associated with the input graph data 110 nodes, an embedding layer 714 is applied on the output of the graph unpooling layer to give the output graph data 408.

The output graph data 408 forms the reconstructed graph. To learn the RGAE 112 model, a reconstruction loss is computed between the reconstructed graph 408 and the input graph data 110. The reconstruction loss comprises matching the nodes of the reconstructed graph and matching the edges in the reconstructed graph. The matching nodes in the input graph data 110 and the reconstructed graph 408 are computed using Hungarian matching in an embodiment. Once the node match is established, an adjacency matrix for the input graph data 110408 and an adjacency matrix for the reconstructed graph are computed. To compute the reconstruction loss for training the RGAE 112, the mean-squared loss between the matched node features and the binary cross-entropy loss between the adjacency matrices of the original and the reconstructed graphs is computed. The computed loss is then used to compute gradients for training the RGAE 112 model.

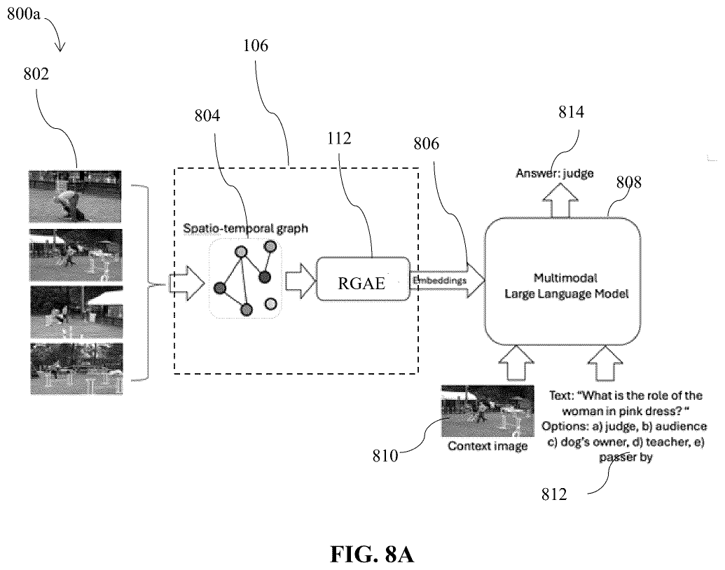

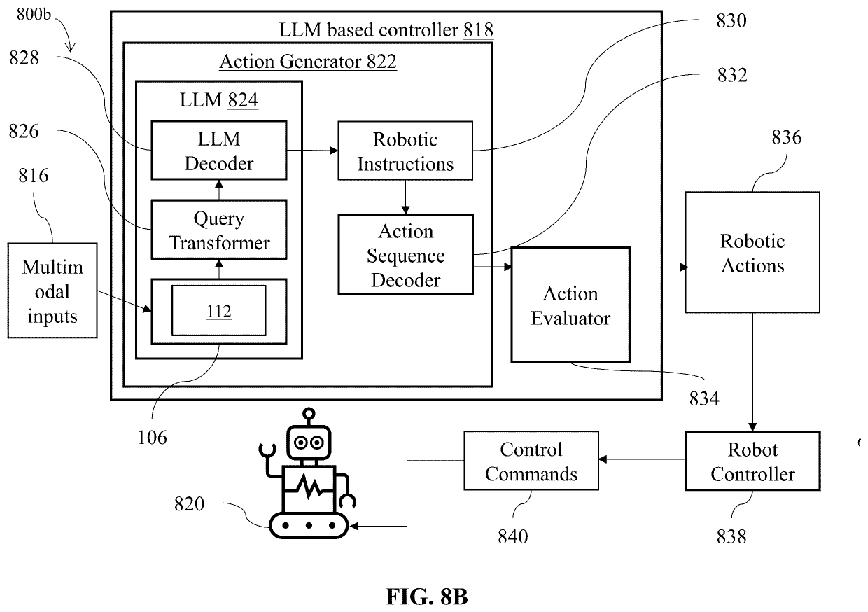

FIG. 8A illustrates a schematic diagram showing an example use case 800a for implementation of the system 106 including the RGAE 112, according to an embodiment of the present disclosure.

The use case 800a illustrates receiving by the system 106, data associated with a scene 802, which includes different frames of input video of the scene 802. The data associated with the scene 802 is equivalent to the input multimodal data 104 shown in FIG. 1. The input data associated with the scene 802 is then converted to a spatio-temporal graph 804, such as by the graph generator 108 shown in FIG. 1. The spatio-temporal graph 804 forms the input graph data 110 which is then processed by the RGAE 112 to extract embeddings 806 corresponding to the spatio-temporal graph 804. The embeddings 806 are equivalent to the embedding feature vector 114 shown in FIG. 1. The embeddings 806 are then transmitted to an LLM 808, which is multimodal LLM. In an embodiment, the LLM 808 may be used for performing a video based question answering task. In an embodiment, the LLM 808 is pre-trained for performing a task based on the embedding feature vector 114 or the embeddings 806. The training may be done on compact representations of the embeddings, which is much easier for the RGAE 112 to process rather than training on full video sequences. Further, all the details from the scene graph for the spatio-temporal graph 804 is compressed in the embeddings 806, which the LLM 808 with the adaptation layer learns to extract, guided by the downstream task. Once this is done, the LLM 808 parameters are frozen and the RGAE 112 encoder as well as the adaptation layer between the RGAE embeddings and the LLM input adapting the RGAE embeddings to be adapted are trained, to look like textual inputs to the LLM 808 so that the LLM 808 can interpret the RGAE 112 features and do reasoning on them.

In an embodiment, the RGAE 112 model is trained for a loss on the downstream task, as well as the RGAE 112 reconstruction loss.

In order to perform the task, a user input 812 corresponding to the task is received. For example, the user input 812 may be a question such as “What is the role of the woman in pink dress”. Along with the question, a context image 810 may also be received by the system 106 as the user input 812. The embeddings 806 are then used to generate response data 814 for the task, based on execution of the LLM 808 using the user input 812 and the context image 810 and the embeddings 806. For example, the response data 814 comprises the answer “judge”.

In some embodiments, the task may be a video summarization task and the RGAE 112 is used to generate summary embeddings 806 for a scene, such as the scene 802, which may then be used to perform captioning and video summarization tasks. In the video summarization task, the LLM 808 generates concise and contextually relevant summaries of video content, such as the scene 802. The LLM 808 processes an input video embeddings 806 which include key audio, visual, and textual features of the scene, as extracted by the RGAE 112. These are then analyzed using the LLM 808 to generate a natural language summary. To that end, the LLM 808 receives the processed input in the form of the embeddings 806 and generates a textual summary by leveraging its contextual understanding, temporal reasoning, and semantic compression capabilities. The summary may be generated in various formats, including short textual abstracts, bullet points, or structured reports, depending on user requirements.

In some embodiments, the LLM 808 may also incorporate user-defined constraints, such as summarization length, emphasis on specific topics, or filtering of irrelevant content. This LLM-driven video summarization can be applied in various domains, including news highlights generation, sports recap automation, educational content summarization, legal video documentation, and surveillance footage analysis. By leveraging the LLM's 808 ability to process multimodal data and generate coherent summaries, the efficiency of reviewing and understanding video content is enhanced.

In some embodiments, the RGAE 112 may be used by a robot to perform an embodied navigation task in a scene.

FIG. 8B illustrates a schematic diagram showing an example use case 800b for implementation of the system 106 including the RGAE 112, according to an embodiment of the present disclosure.

The system 106 may be used to control a robot 820 based on multimodal inputs 816 that are processed by an LLM based controller 818. The LLM based controller 818 includes an action generator 822 which embodies the system 106 as part of an LLM 824 module, according to an example embodiment. The multimodal inputs 816 are provided to the LLM based controller 818, where the system 106 receives these multimodal inputs 816, and the RGAE 112 extracts four types of features: video, image, audio, and speech (text). An input to the system 106 module may be a human demonstration video. The output of the RGAE 112 may be an intermediate feature hm, which may be the embedding feature vector 114. The output of the system 106, in the form of the embedding feature vector 114 may be passed to a query transformer 826 that is trained to bridge the gap between the multiple modalities in the input 816 and text modality accepted by an LLM decoder 828. The LLM decoder 828 generates an action sequence y in the form of robotic instructions 830 from the text feature

$${h}_{m}^{′}$$

obtained by the query transformer 826. The LLM decoder 828 is constructed with a frozen LLM and a learnable feed-forward layer. Using the LLM as a decoder leverages the LLM's inference capabilities when generating action sequences. The robotic instructions 830 generated by the LLM decoder 828 are transformed to action sequences by an action sequence decoder 832. These action sequences are evaluated by an action evaluator 834, that may be integrated as a validation layer that determines which action of a set of actions is the best candidate to be output in the robot action sequence output by the action sequence decoder 832. In such embodiments, the output of the action sequence decoder 832 is further evaluated and next actions can be validated using the action evaluator 834. The validated actions are then selected as robotic actions 836. The robotic actions 836 may be expressed in terms of robotic skills associated with the robot 820. For example, each operation demonstrated in the multimodal input 816 may be subdivided or broken into sub-operations that are expressed in terms of the robot skills. The robotic actions 836 thus generated are output to a robot controller 838 that generates control commands 840 in response to the skills described in each of the robotic actions 836. The control commands 840 specify values of currents and voltages and time durations of supply of current/power to one or more actuators of the robot 820. Thus, the robot 820 is controlled according to the sequence of actions predicted in accordance with the instructions specified in the multimodal demonstration input 816, according to an embodiment.

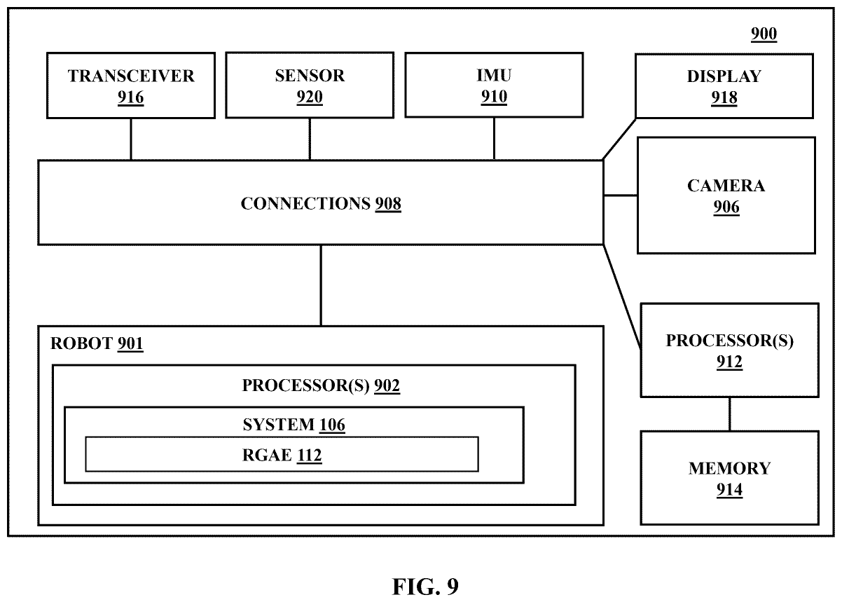

To that end, the robot 820 may be controlled by a control system which embodies the system 106 and uses the LLM based controller 818 to control the robot 820. Such a control system is further illustrated in FIG. 9, as an example.

FIG. 9 illustrates some components of a control system 900 for controlling a robot 901 according to a task, according to some embodiments. The control system 900 comprises communication interfaces such as a transceiver 916, sensors 920, input interfaces such as an inertial measurement unit (IMU) 910, output interfaces such as a display 918, one or more visual sensors such as a camera 906, computational circuitry realized through one or more processors 912 and memory 914. One or more connection buses 908 may couple the components of the control system 900 with each other. According to some embodiments, the control system 900 may also be coupled with the robot 901. The robot 901 comprises suitable processing circuitry realized through processors 902 and memory that stores the system 106 and the RGAE 112.

According to some embodiments, the modules described regarding FIG. 1 to FIG. 8B may be executed by the processing/computation circuitry of the control system 900 to cause robot control in accordance with various embodiments described herein.

The system 106 and the RGAE 112 may be used in a similar manner in any environment where multimodal input data may be captured, and the RGAE 112 may generate compact representations of the multimodal input data in the form of embedding vectors 114, that may be used with LLM based systems to perform any tasks. The recursive architecture 402 of the RGAE 112 allows efficient compacting and decoding of the multimodal input data, only till the extent, as is required by the underlying task. This ensures computing and processing resources are utilized optimally, and processing time is also reduced, thereby increasing efficiency of task performance in such LLM based systems.

The above description provides exemplary embodiments only and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as outlined in the appended claims.

Specific details are given in the above description to provide a thorough understanding of the embodiments. However, understood by one of the ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail to avoid obscuring the embodiments. Further, like reference numbers and designations in the various drawings indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware, or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of several suitable programming languages and/or programming or scripting tools and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described concerning certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A recursive architecture for a graph auto-encoder, comprising a processor; and a memory having instructions stored thereon that when executed by the processor, cause the processor to execute modules comprising:
a graph-based encoder configured to recursively encode input graph data into a latent representation, the latent representation comprising an embedding feature vector corresponding to the input graph data; and
a transformer-based decoder configured to recursively decode the latent representation into output graph data using different numbers of learned query embeddings for at least some of iterations of the recursive decoding.

2. The recursive architecture for the graph auto-encoder of claim 1, wherein the transformer-based decoder further comprises encoder metadata, the encoder metadata associated with a selection of the different numbers of learned query embeddings.

3. The recursive architecture for the graph auto-encoder of claim 1, wherein the output graph data comprises a neural feature vector corresponding to the input graph data.

4. The recursive architecture for the graph auto-encoder of claim 1, wherein the graph-based encoder comprises a subgraph pooling module, wherein the subgraph pooling module is configured to iteratively encode a subgraph associated with the input graph data into a corresponding node associated with the corresponding iteration of the subgraph pooling module.

5. The recursive architecture for the graph auto-encoder of claim 1, wherein the graph-based encoder comprises:
a vertex cover graph tokenizer configured to determine a minimum vertex cover for the input graph data;
a subgraph pooling module configured to generate nodes corresponding to one or more subgraphs in the minimum vertex cover; and
a reduced graph generator configured to generate a reduced subgraph based on the generated nodes, wherein one or more edges are added between one or more nodes of the generated nodes based on a hop distance associated with the one or more nodes.

6. The recursive architecture for the graph auto-encoder of claim 1, wherein the embedding feature vector is used in performance of a task.

7. The recursive architecture for the graph auto-encoder of claim 6, wherein the transformer-based decoder is configured to recursively decode the latent representation into the output graph data based on the task, such that an extent of the recursive decoding performed by the transformer-based decoder is determined based on the task.

8. A method for recursive graph auto-encoder, wherein the method uses a processor coupled with stored instructions implementing the method, wherein the instructions, when executed by the processor carry out steps of the method, comprising:
receiving input graph data associated with a scene;
encoding recursively the input graph data into a latent representation, the latent representation comprising an embedding feature vector corresponding to the input graph data; and
decoding recursively the latent representation into output graph data using different numbers of learned query embeddings for at least some of iterations of the recursive decoding.

9. The method of claim 8, further comprising outputting the embedding feature vector.

10. The method of claim 8, further comprising:
transmitting the embedding feature vector to a large language model (LLM), the LLM being pre-trained for performing a task based on the embedding feature vector;
receiving a user input corresponding to the task; and
generating response data for the task, based on execution of the LLM using the user input and the embedding feature vector.

11. The method of claim 10, wherein the task is a video based question answering task.

12. The method of claim 10, wherein the task is a video summarization task.

13. The method of claim 10, wherein the task comprises controlling a robot based on the generated response data.

14. The method of claim 8, wherein the encoding recursively the input graph data into the latent representation comprises:
determining a minimum vertex cover for the input graph data;
generating nodes corresponding to one or more subgraphs in the minimum vertex cover based on execution of a subgraph pooling operation; and
generating a reduced subgraph based on the generated nodes, wherein one or more edges are added between one or more nodes of the generated nodes based on a hop distance associated with the one or more nodes.

15. The method of claim 8, wherein the decoding recursively the latent representation into the output graph data comprises:
receiving the latent representation and a set of learnable query embeddings, wherein the set of learnable query embeddings comprises the learned query embeddings;
extracting subgraphs from the latent representation based on an application of the learned query embeddings to a subgraph unpooling operation, wherein the subgraph unpooling operation is associated with a transformer model; and
generating a compact graph based on the extracted subgraphs and the set of learnable query embeddings.

16. The method of claim 8, further comprising:
generating one or more vertex cover nodes for the input graph data, wherein each of the vertex cover nodes comprises a minimum vertex cover node associated with the input graph data.

17. A system comprising:
a memory configured to store one or more computer executable instructions; and
a processor configured to execute the one or more computer executable instructions to cause the processor to:
receive input graph data associated with a scene;
encode recursively the input graph data into a latent representation, the latent representation comprising an embedding feature vector corresponding to the input graph data; and
decode recursively the latent representation into output graph data using different numbers of learned query embeddings for at least some of iterations of the recursive decoding.

18. The system of claim 17, wherein the processor is further caused to:
execute a graph generator to generate the input graph data based on input multimodal data associated with the scene, the graph generator comprising:
an object detector configured to detect one or more objects in the scene; and
a relationship detector configured to detect one or more relationships between the detected one or more objects in the scene.

19. The system of claim 17, wherein the processor is caused to output the embedding feature vector.

20. The system of claim 17, wherein the processor is caused to:
transmit the embedding feature vector to a large language model (LLM), the LLM being pre-trained for performing a task based on the embedding feature vector;
receive a user input corresponding to the task; and
generate response data for the task, based on execution of the LLM using the user input and the embedding feature vector.
